(19) United States
(12) Patent Application Publication
(10) Pub. No.: US 2006/0216559 A1
(43) Pub. Date: Sep. 28, 2006

(54) Co-generation of electricity by the seebeck effect within a fuel cell

(76) Inventors: Gerard Olivier, Bougival (FR); Sebastien Samuel, Versailles (FR); Robert Yu, Elancourt (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/560,822

(22) PCT Filed: Jun. 14, 2004
(86) PCT No.: PCT/FR04/01480

§ 371 Date: Apr. 5, 2006

(30) Foreign Application Priority Data
Jun. 16, 2003 (FR) 03/07187

(51) Int. Cl. H01M 8/04; H01M 8/24

(52) U.S. Cl. 429/26; 429/13

(57) ABSTRACT

A fuel cell that includes at least two elementary cells for exothermic combustive reaction, including a heat source and an internal channel, formed between the cells for the circulation of a cooling fluid, which forms a cooling source. The cell includes a number of thermoelectric modules, each made of a couple of two conducting material elements of differing nature, a first end of each couple being in thermal contact with the heat source or the cooling source, the second end of each of the elements of the couple being in contact with the other source and electrically connected to an adjacent module.

The present invention relates to a fuel-cell stack and to a method for recuperation of thermal energy as electrical energy.

Fuel-cell stacks permit direct conversion of the free energy of a chemical oxidation-reduction reaction to electrical energy and, in the motor vehicle field, they appear to be one of the most promising current technologies for satisfying the European requirements of pollution and consumption reduction.

However, the disadvantage of the system lies in the management of the thermal energies. In fact, the cooling circuit of a fuel-cell stack must evacuate approximately 1.5 times as much thermal energy as the electrical power produced. This constitutes a large energy loss, which greatly reduces the efficiency of the system.

It therefore is advantageous to obtain means capable of utilizing the thermal power discharged by the fuel-cell stack, by transforming it into energy that the vehicle can use.

German Patent DE 19825872 describes a fuel-cell stack of the high-temperature SOFC type enclosed in a double-wall encapsulation composed of a hot wall in contact with the cell stack and a cold wall cooled by any appropriate medium. Between these two walls there are disposed thermoelectric elements that produce an electric current by virtue of the temperature difference to which they are exposed between these two walls. Since the thermal energy recuperation system is located outside the fuel-cell stack, the observed heat losses make it impossible to obtain an advantageous efficiency with this known device.

The object of the invention is a fuel-cell stack comprising means for recuperating, in the form of electrical energy, the thermal energy produced by the cell stack, limiting the energy losses as much as possible and making it possible to obtain an improved efficiency, as well as a method for recuperation of thermal energy in the form of electrical energy in such a fuel-cell stack.

The fuel-cell stack according to the invention comprises at least two elementary cells, disposed in facing relationship, for an exothermic combustion reaction constituting a heat source, and an internal duct formed between the cells for circulation of a cooling fluid constituting a cold sink. This cell stack comprises a plurality of thermoelectric modules, each comprising a pair of elements of two conductive materials of dissimilar nature. A first end of each pair is in thermal contact with the heat source or the cold sink, while the second end of each of the elements of the said pair is in contact with the other source or sink, and is electrically connected to a neighboring module.

By virtue of this plurality of thermoelectric modules disposed in the very interior of the cell stack, the thermal energy produced by the cells of the cell stack is converted to electrical energy, while minimizing the energy losses of the system. In addition, this embodiment is simpler to implement and is less costly.

Preferably, the fuel-cell stack used is a membrane cell stack of the PEM type.

In an advantageous embodiment, the thermoelectric module is composed of a pair of conductive materials connected at one of their ends by a thermally and electrically conductive connection in thermal contact with the heat source, and connected to one another at their free ends by a thermally and electrically conductive connection in thermal contact with the cold sink.

In a preferred embodiment, the two conductive materials of the thermoelectric modules are semiconductors, one of P type, or in other words a positively doped semiconductor, and the other of N type, or in other words a negatively doped semiconductor.

In an advantageous embodiment, the N-type materials are alloys of silicon and germanium doped with phosphorus. The P-type materials are alloys of silicon and germanium doped with boron.

Advantageously, the conductive connections connecting the ends of the materials are composed of molybdenum electrodes.

In a preferred embodiment, the last thermoelectric module of an assembly disposed along a first elementary cell is electrically connected in series or in parallel with the first thermoelectric module of an assembly disposed along a second elementary cell.

Advantageously, a plate forming a wall equipped with fins is disposed on the external surface of an assembly of thermoelectric modules, constituting a boundary of the cooling duct, the fins being disposed on the same side as the cooling duct in order to favor heat exchange.

The method of the invention for recuperating, in the form of electrical energy, thermal energy originating from a fuel-cell stack utilizes, as cold sink, a cooling fluid circulating in the interior of the fuel-cell stack between two elementary cells of that same cell stack constituting the heat source. This cooling fluid is placed in thermal contact with a plurality of thermoelectric modules. Thus the electrical energy generated by the Seebeck effect is recuperated.

Preferably, the method of the invention uses a membrane cell stack of PEM type as the fuel-cell stack.

Advantageously, this method implements two-phase cooling of the cell stack.

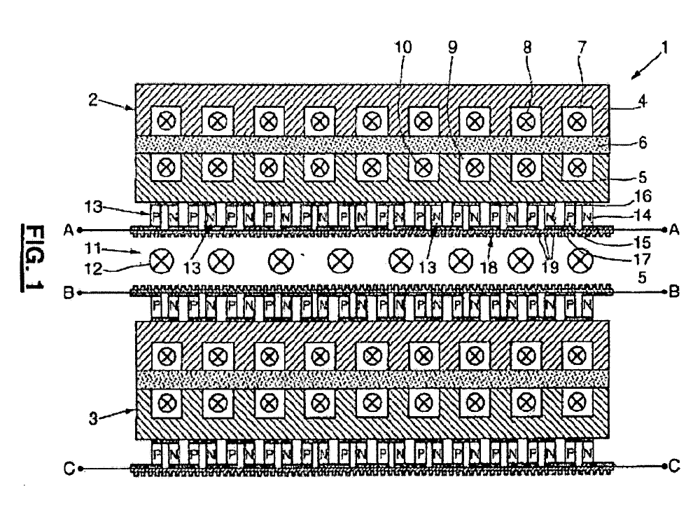

The invention will be better understood by studying the detailed description of a practical example, in no way a limitative example, illustrated by FIG. 1, very schematically showing two elementary cells of a fuel-cell stack according to the invention.

FIG. 1 shows an assembly 1 of two cells of a fuel-cell stack mounted on board a motor vehicle with PEM (proton exchange membrane) technology. The fuel-cell stack is composed of a succession of elementary electricity-producing cells. Only two elementary cells 2 and 3 are shown in FIG. 1. These elementary cells 2 and 3 are composed of two bipolar plates 4 and 5 separated by a porous membrane 6. On the surface of bipolar plate 4 there are engraved ducts 7, in which there circulates oxygen 8. Similarly, on the surface of bipolar plate 5 there are engraved ducts 9, in which there circulates hydrogen 10. The oxygen and hydrogen circulate perpendicularly to the plane of the figure. Since the reaction that takes place in this cell is exothermic, the temperature of bipolar plates 4 and 5 tends to rise. It is therefore necessary to cool them in order to evacuate the calories.

The two producing cells 2 and 3 define an internal cooling duct 11, in which there circulates a heat-transfer fluid 12 that evacuates the calories outside the cell stack. The heat-transfer fluid circulates in a direction perpendicular to the plane of FIG. 1. At the outlet of the cell stack, fluid 12 is cooled by means of heat exchangers not illustrated in the figure, and is reintroduced in cold condition at the inlet of the fuel-cell stack.

The means that permit conversion of the thermal energy into electrical energy comprise a plurality of thermoelectric modules 13. This assembly of thermoelectric modules is disposed between bipolar plate 5 of elementary cell 2 constituting the heat source and internal cooling duct 11, in which there circulates cooling fluid 12, which constitutes the cold sink. These modules are composed of two conductive materials 14 and 15 of dissimilar nature, connected at one of their ends by a thermally and electrically conductive connection 16 in thermal contact with heat source 5. At their free ends the thermoelectric modules are connected in series by a thermally and electrically conductive connection 17 in thermal contact with cold sink 12.

The pairs of materials 14 and 15 are matched to the temperature level of the cell stack and of the cooling circuit.

As an example, the conductive materials that constitute the thermoelectric modules are semiconductor materials. Of dissimilar nature, one is P-type, or in other words a positively doped semiconductor, and the other is N-type, or in other words a negatively doped semiconductor. The P-type semiconductors are, for example, alloys of silicon and germanium doped with boron. The N-type semiconductors are, for example, alloys of silicon and germanium doped with phosphorus.

Conductive connections 16 and 17 connecting the ends of materials 14 and 15 are composed of molybdenum electrodes.

By means of connections A, B or C, the last thermoelectric module of an assembly disposed along a first elementary cell is electrically connected in series or in parallel with the first thermoelectric module of an assembly disposed along a second elementary cell.

A plate 18 forming a wall equipped with fins 19 is disposed on the external surface of the assembly of thermoelectric modules on the same side as internal cooling duct 11, the fins being disposed on the same side as internal cooling duct 11. The addition of fins to the wall makes it possible to improve heat exchange.

In other words, bars of conductive materials 14 and 15 of dissimilar nature are disposed alternately as crosspieces between an elementary cell 2 or 3 of a fuel-cell stack 1 and internal cooling duct 11 adjacent to that cell 2 or 3. These bars of conductive materials 14 and 15 are connected alternately in pairs by thermally and electrically conductive connections, some 16 along elementary cell 2 or 3 constituting the heat source and the others 17 along internal cooling duct 11, cooling fluid 12 constituting the cold sink. This succession of bars of conductive materials constitutes the plurality of thermoelectric modules 13.

In a preferred embodiment, a wall 18 composed of fins 19 is disposed perpendicularly to the succession of bars of conductive materials 14 and 15, along conductive connections 17, constituting a boundary of internal cooling duct 11.

The method of implementation advantageously utilizes two-phase cooling of the fuel-cell stack. In this type of cooling, the fluids evacuate the heat by evaporating at constant temperature. It will be possible to choose this temperature as a function of the desired operating temperature of the cell stack, in order to optimize the recuperated power. For this purpose, the heat-transfer fluid will be chosen as a function of its temperature.

1-9. (canceled)

10. A fuel-cell stack comprising:
at least two elementary cells disposed in facing relationship, for an exothermic combustion reaction constituting a heat source;
an internal duct formed between the cells for circulation of a cooling fluid constituting a cold sink; and
a plurality of thermoelectric modules, each comprising a pair of elements of two conductive materials of dissimilar nature, a first end of each pair being in thermal contact with the heat source or the cold sink, a second end of each of the elements of the pair being in contact with the other source or sink, and being electrically connected to a neighboring module.

11. A fuel-cell stack according to claim 10, wherein the thermoelectric module is composed of a pair of conductive materials connected at one of their ends to a conductive connection in thermal contact with a plate of the heat source, and connected to one another at their free ends by a conductive connection in thermal contact with the cold sink.

12. A fuel-cell stack according to claim 10, wherein the two conductive materials of the thermoelectric modules are semiconductor materials, a first of P type and a second of N type.

13. A fuel-cell stack according to claim 12, wherein the N-type materials are alloys of silicon and germanium doped with phosphorus and the P-type materials are alloys of silicon and germanium doped with boron.

14. A fuel-cell stack according to claim 10, wherein the conductive connections connecting the ends of the materials are composed of molybdenum electrodes.

15. A fuel-cell stack according to claim 10, wherein a last thermoelectric module of an assembly disposed along a first elementary cell is electrically connected in series or in parallel with a first thermoelectric module of an assembly disposed along a second elementary cell.

16. A fuel-cell stack according to claim 10, wherein a plate forming a wall equipped with fins is disposed on the external surface of the assembly of thermoelectric modules on a same side as the internal cooling duct.

17. A method for partial recuperation of thermal energy originating from a fuel-cell stack, in an interior of which there circulates, between two elementary cells of the fuel-cell stack constituting the heat source, a cooling fluid constituting the cold sink, wherein the cooling fluid is placed in thermal contact with a plurality of thermoelectric modules and the electrical energy generated by Seebeck effect is recuperated.

18. A method according to claim 17, wherein cooling of the cell stack is two-phase.
